(19) United States
(12) Patent Application Publication
(10) Pub. No.: US 2007/0165848 A1
(43) Pub. Date: Jul. 19, 2007

(54) Lightweight pseudo-random number generator

(76) Inventor: Sergio Reyes, Austin, TX (US)

Correspondence Address: IBM CORP (YA);C/O YEE & ASSOCIATES PC, P.O. BOX 802333, DALLAS, TX, 75380, US

(21) Appl. No.: 11/334,698

(22) Filed: Jan. 18, 2006

(51) Int. Cl. H04L 9/00

(52) U.S. Cl. 380/46

(57) ABSTRACT

A computer implemented method, data processing system, and computer usable code are provided for generating random numbers. The aspects of the present invention receive a request for a number of random numbers and determine common denominators for the number of random numbers. Grid dimensions are determined using the common denominators and a static pattern is retrieved using the grid dimensions. A list of random numbers is then generated using the static pattern and the grid dimensions and the list of random numbers is returned to a requestor.

### BACKGROUND OF THE INVENTION

1. Field of the Invention

The present invention relates generally to random number generation. More particularly, the present invention relates to a pseudo-random number generator that generates an infinite number of random numbers without duplicates based on a much smaller user-defined subset.

2. Description of the Related Art

Randomness is not as cut-and-dried as you might think, that is, some streams of numbers are more random than others. Computers, being completely deterministic machines, are particularly bad at behaving randomly. In fact, the only true sources for random numbers involve measuring physical phenomena, such as the timing of radioactive decay, which can be distilled into purely random sequences using some mathematical tricks. Without access to physical devices, computer programs that need random numbers are forced to generate the numbers themselves. But the determinism of computers makes this algorithmically quite difficult. As a result, most programmers turn to pseudo-random numbers.

How do pseudo-random number generators work? A computer function random( ) really invokes a pseudo-random number generator. But what is a pseudo-random number generator? Suppose a request is made to generate a random number between 1 and 10, where every number has an equal probability of appearing. Ideally, a value would be generated on the range from 0 to 1 where every value will occur with equal probability, regardless of the previous value, then multiply that value by 10. Note that there are an infinite number of values between 0 and 1. Also, note that computers do not offer infinite precision.

To write code to implement something like the algorithm presented above, a pseudo-random number generator typically produces an integer on the range from 0 to N, and returns that number divided by N. The resulting number is always between 0 and 1. Subsequent calls to the generator take the integer result from the first run and pass it through a function to produce a new integer between 0 and N, and then return the new integer divided by N. That means the number of unique values returned by any pseudo-random number generator is limited by the number of integers between 0 and N.

In most common random number generators, N is 2³²−1 (approximately 4 billion), which is the largest value that will fit into a 32-bit number. Put another way, there are at most 4 billion possible values produced by the sort of number generator encountered most often. Actually, 4 billion numbers is not all that large.

A number known as the “seed” is provided to a pseudo-random number generator as an initial integer to pass through the function. The seed gets the ball rolling to generate a value. The output of a pseudo-random number generator contains nothing that is unpredictable. Each value returned by a pseudo-random number generator is completely determined by the previous value it returned and ultimately, the seed that started it all. If the integer used to compute any one value is known, then one can figure out every subsequent value returned from the generator.

In the end, a pseudo-random number generator is a deterministic program that produces a completely predictable series of numbers (called a stream). A well-written PRNG creates a sequence that shares many of the same properties as a sequence of real random numbers. For example:

The PRNG can generate any number in a range with equal probability.

The PRNG can produce a stream with any statistical distribution.

The stream of numbers produced by the PRNG can lack discernible patterns.

What pseudo-random number generators can not do is be unpredictable. If the seed is known, and the algorithm is known, one can easily figure out the sequence.

Thus, three problems are present in generating a list of random numbers. First, a list must be maintain to verify that duplicate numbers are not being generated; second, a check must be performed of the list for duplicates; and third, there is the overhead of reiterating the entire process many more times than the number of random numbers indicated to be attained.

These problems are exemplified when measuring random I/O performance, where a list of addresses must be maintained for the test case to traverse through and use when referencing the file. A pre-generated list of addresses will not allow the flexibility of measuring different test cases, (e.g. smaller or larger files).

Generating random numbers dynamically results in overhead that prevents the random I/O test case from reporting accurate response time and CPU consumption. Using built in pseudo-random generators like the random( ) function, does not guarantee reproducibility across operating systems.

### SUMMARY OF THE INVENTION

The different aspects of the present invention provide a computer implemented method, data processing system, and computer usable code for generating random numbers. A request for a number of random numbers is received and common denominators are determined for the number of random numbers. Using the common denominators, grid dimensions are determined and a static pattern is retrieved using the grid dimensions. A list of random numbers is then generated using the static pattern and the grid dimensions. Finally, a list of random numbers is returned to a requestor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the aspects of the present invention may be implemented;

FIG. 2 is a block diagram of a data processing system is shown in which aspects of the present invention may be implemented;

FIG. 3 depicts an exemplary functional block diagram for a pseudo-random number generator in accordance with an illustrative embodiment of the present invention;

FIG. 4 depicts exemplary pseudo-code for a pseudo-random number generator in accordance with an illustrative embodiment of the present invention

FIG. 5 depicts an exemplary grid in which random numbers may be generated in accordance with an illustrative embodiment of the present invention;

FIGS. 6A-6C depict an exemplary generation of twelve pseudo-random numbers in accordance with an illustrative embodiment of the present invention;

FIGS. 7A-7D depict an exemplary generation of forty-eight random numbers in accordance with an illustrative embodiment of the present invention; and

FIG. 8 depicts a flowchart operation for generating pseudo-random numbers using a pseudo-random number generation application in accordance with an illustrative embodiment of the present invention.

### DETAILED DESCRIPTION OF THE PREFERRED EMBODIMENT

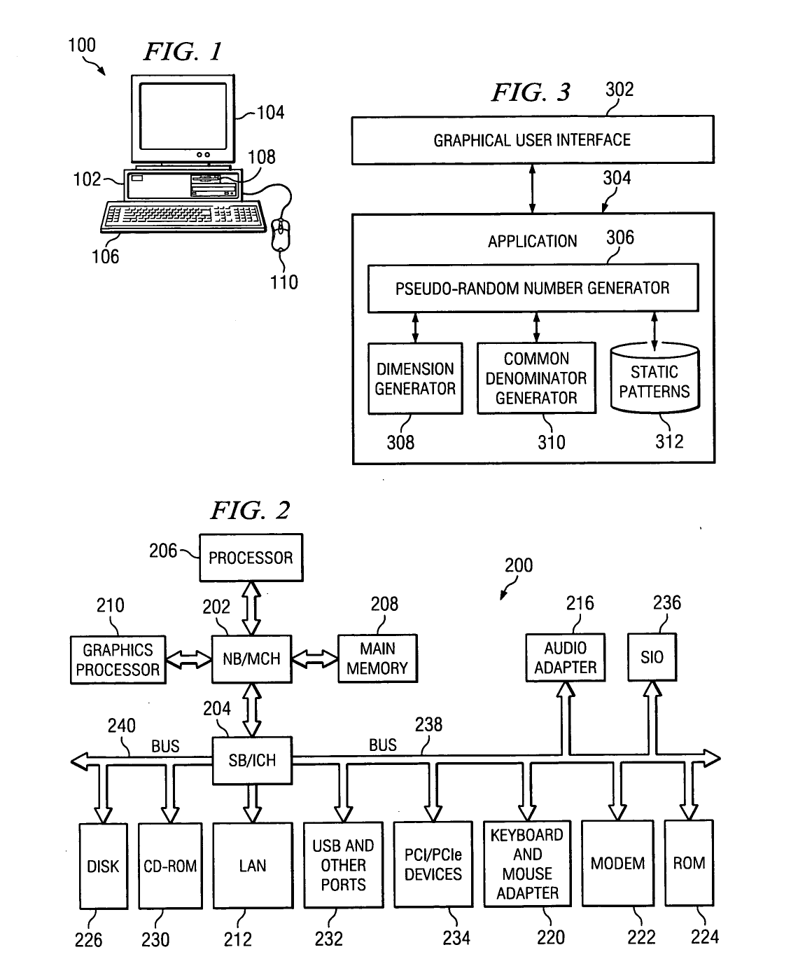

The present invention relates to a pseudo-random number generator that generates an infinite number of random numbers without duplicates based on a much smaller user-defined subset. With reference now to the figures and in particular with reference to FIG. 1, a pictorial representation of a data processing system in which the aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

An aspect of the present invention generates an infinite number of random numbers without duplicates based on a much smaller user-defined subset. The smaller subset is expanded to fit the target range of random numbers. The described random number generation does not require the user to maintain a list of numbers to verify for duplicates. There is a lower overhead in that a unique random number is produced every time the method is invoked, and produces reproducible results, even across different operating systems.

FIG. 3 depicts an exemplary functional block diagram for a pseudo-random number generator in accordance with an illustrative embodiment of the present invention. Graphical user interface 302 provides an interface for a requestor to access pseudo-random number generator application 304. A requestor may be any type of requesting device, for example a user, another application, or a software module. Pseudo-random number generator application 304 is composed of pseudo-random number generator 306, dimension generator 308, common denominator generator 310, and static patterns database 312. As pseudo-random number generator application 304 is invoked, common denominator generator 310 generates a set of common denominators for the number of requested pseudo-random numbers.

Based on the common denominator generated by common denominator generator 310, dimension generator 308 generates dimensions for a grid capable of generating the requested number of pseudo-random numbers. Once the dimensions of the grid are determined, a static pattern that conforms to the determined dimensions is retrieved from static patterns database 312. Static patterns database 312 contains list of static patterns. Static patterns database 312 may be any type of data structure, such as a memory or a disc. Using the static pattern retrieved from static patterns database 312, pseudo-random number generator 306 generates a list of the requested amount of pseudo-random numbers.

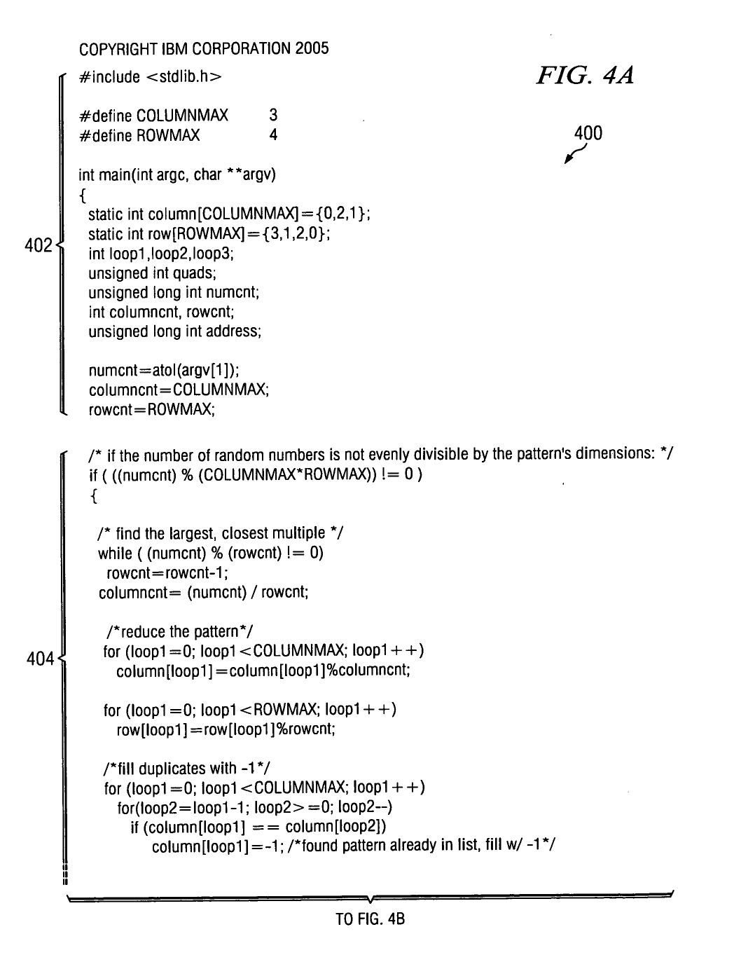

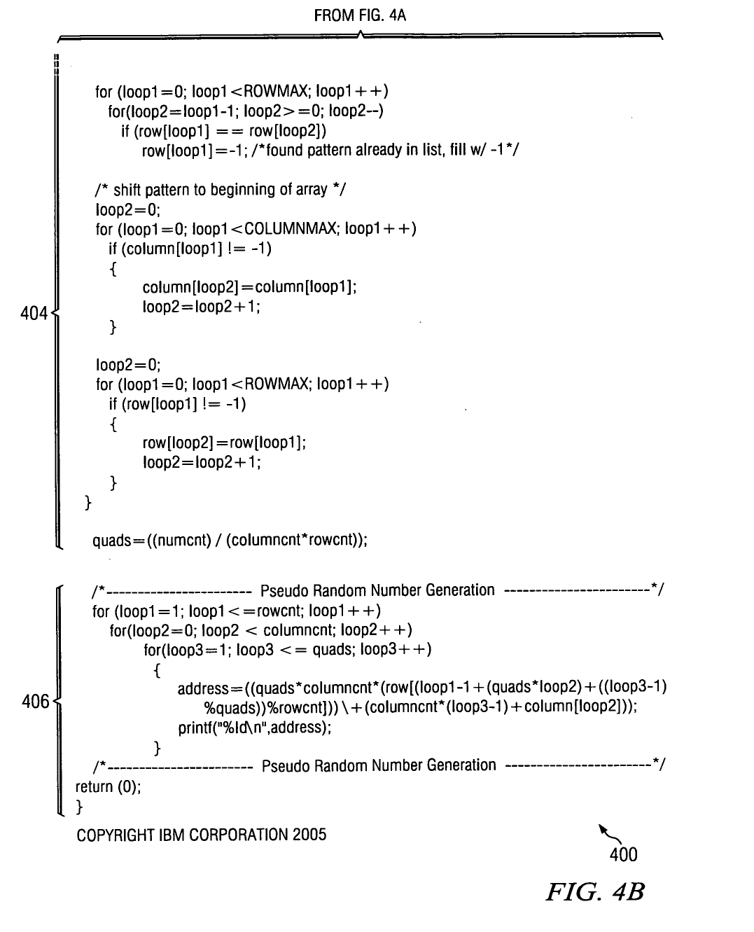

FIG. 4 depicts exemplary pseudo-code for a pseudo-random number generator in accordance with an illustrative embodiment of the present invention. In section 402, variable information is defined for the calculation of pseudo-random numbers. The pseudo-code shown in section 406 may be located within pseudo-random number generator 306 of FIG. 3. Although pseudo-code 400 is shown in a C programming language, any type of programming language may be used to implement the pseudo-random number generator. In defining the variable information, values may be static values within the code, static variables retrieved from a data structure, or dynamic variables obtained by querying a requestor. The variables defined within pseudo-code 400 are not intended to be limiting and are purely illustrative. Section 404 depicts exemplary pseudo-code for extracting common denominators for a requested number of random numbers, defining dimensions of a grid necessary to generate the requested number of pseudo-random numbers, and retrieving a static pattern based on the common denominators extracted. Section 406 depicts exemplary pseudo-code for pseudo-random number generation.

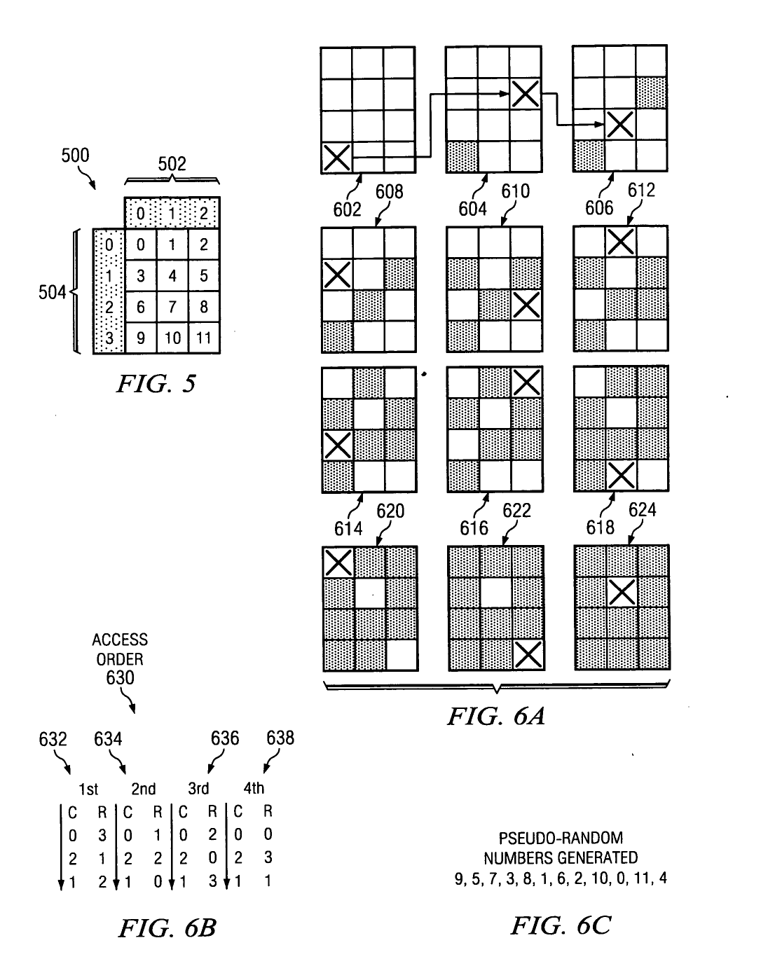

FIG. 5 depicts an exemplary grid in which random numbers may be generated in accordance with an illustrative embodiment of the present invention. Exemplary grid 500 is a grid of columns 502 and rows 504. In exemplary grid 500, the dimension of columns 502 is three columns wide, and the dimension of rows 504 is four rows deep. The dimensions of the grid may be determined using dimensions generator 308 of FIG. 3. Using a grid of the dimensions three by four is capable of generating twelve numbers, such as numbers 0-11. Using a pre-generated static pattern list in conjunction with exemplary grid 500, a set of random numbers may be generated. An exemplary static pattern would be a value set of columns: {0,2,1} and rows: {3,1,2,0}. Exemplary grid 500 is shown to be three by four, which are common denominators of generating twelve numbers; however, other common denominators may also be used, such as two by six. The common denominator of twelve may be determined using common denominator 310 of FIG. 3.

FIG. 6A depicts an exemplary generation of twelve pseudo-random numbers in accordance with an illustrative embodiment of the present invention. Generation 600 of twelve pseudo-random numbers is based on dimensions three by four and a static pattern value set of columns: {0,2,1} and rows: {3,1,2,0}. The dimensions of the grid and the static pattern used in this example may be determined using dimensions generator 308 and static patterns 312 of FIG. 3. In generating an access order for twelve random numbers, the column value set and the row value set are interleaved. The column value set is maintained in order while the row value set is used in order until the pattern of the column value set is exhausted. The second time the column value set is repeated, the entry for the row column starts with the second entry of the row value set. This pattern is repeated until all possible combinations are generated.

FIG. 6B depicts an exemplary access order process in accordance with an illustrative embodiment of the present invention. Access order 630 depicts the access order pattern that is generated in order to provide twelve random numbers. Using the static pattern value set of columns: {0,2,1} and rows: {3,1,2,0}, repetitions 632, 634, 636, and 638 of the column value set are required to produce twelve random numbers. In a first repetition, repetition 632, the row value starts with the first entry in the row value set, in a second repetition, repetition 634, the row value starts with the second entry in the row value set, in repetition 636 the row value starts with the third entry in the row value set, and in repetition 638 the row value starts with the fourth entry in the row value set.

Returning to FIG. 6A, a list of twelve random numbers is generated using access order 630. The first entry in access order 630 is column 0, row 3, which is shown marked in grid 602. The second entry of access order 630 is column 2, row 1, which is shown marked in grid 604. The remaining entries of access order 630 is shown in respective entries in grids 606-624. Using exemplary grid 400 of FIG. 4, the random numbers correlating the each grid entry of grids 602-624 are derived. For grid 602, the related random number is 9, for grid 604, the related random number is 5, and so on through grids 606-624. Thus, the list of random numbers generated is depicted in FIG. 6C in accordance with an illustrative embodiment of the present invention.

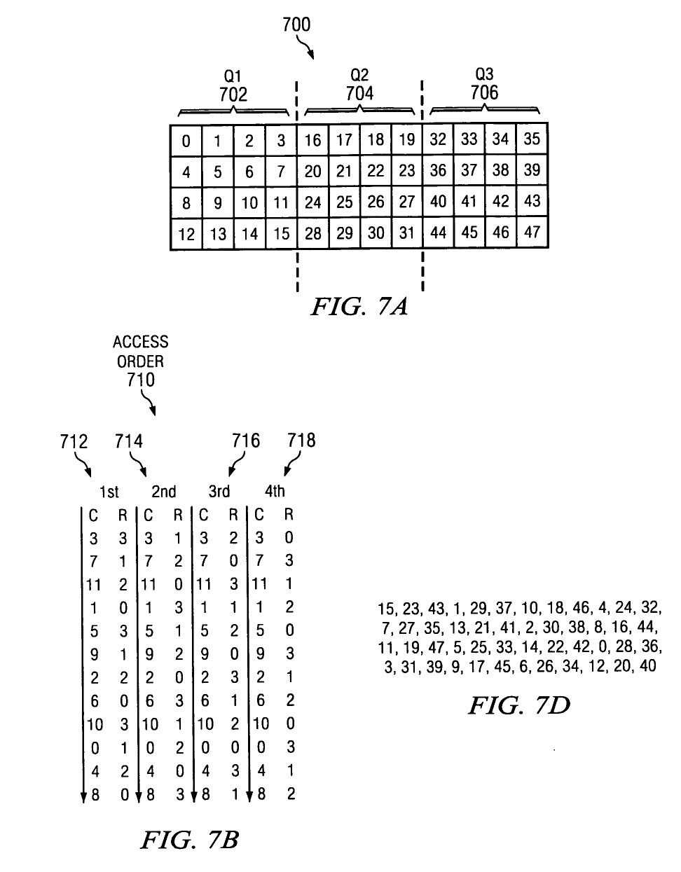

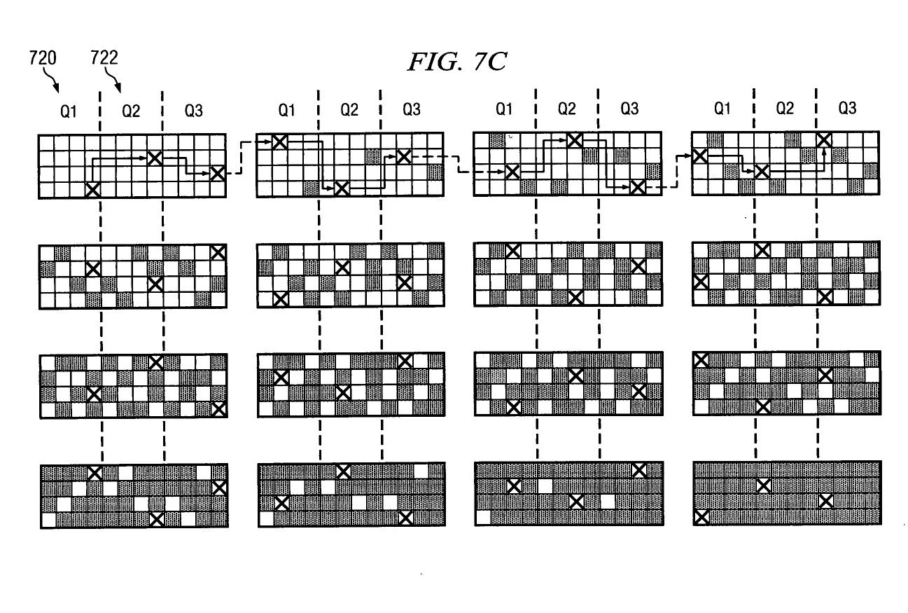

In order to handle a larger range of random numbers, such as (0-47), another level of abstraction is added, which is exemplary shown as quadrants. For random number ranges that are not a multiple of the quadrant size, modification to the column and row patterns may be performed. These patterns are dynamically reduced to form a quadrant size that is a multiple of the random number address space. FIG. 7A depicts an exemplary grid capable of producing forty-eight random numbers in accordance with an illustrative embodiment of the present invention. In order to generate forty-eight random numbers, the process may be applied two or three times; for example, once on the range (0-15), quadrant 1 (Q1) 702, then on range (16-31), quadrant 2 (Q2) 704, and then on range (32-47), quadrant 3 (Q3) 706. In exemplary grid 700, address access is also interleaved first across quadrants, then across rows. Using an exemplary static pattern value set of columns: {3,7,11,1,5,9,2,6,10,0,4,8} and rows: {3,1,2,0}, forty-eight random numbers may be generated.

FIG. 7B depicts an exemplary access pattern used to produce forty-eight random numbers in accordance with an illustrative embodiment of the present invention. Access order 710 requires repetitions 712, 714, 716, and 718 of the column value set to produce forty-eight random numbers. Once again, in the first repetition, repetition 712, the row value starts with the first entry in the row value set, in the second repetition, repetition 714, the row value starts with the second entry in the row value set, in repetition 716 the row value starts with the third entry in the row value set, and in repetition 718 the row value starts with the fourth entry in the row value set.

Turning to FIG. 7C, a list of forty-eight random numbers are generated using access order 710 in accordance with an illustrative embodiment of the present invention. The first entry in access order 710 is column 3, row 3, which is shown marked in grid 720. The second entry of access order 710 is column 7, row 1, which is shown marked in grid 722. The remaining entries of access order 710 is shown in respective entries in the other grids in FIG. 7C. Using exemplary grid 700 of FIG. 7A, the random numbers correlating each grid entry of grids in FIG. 7C may be derived. For grid 720, the related random number is 15, for grid 722, the related random number is 23, and so on through the other grids. Thus, the list of forty-eight random numbers generated is depicted in FIG. 7D in accordance with an illustrative embodiment of the present invention.

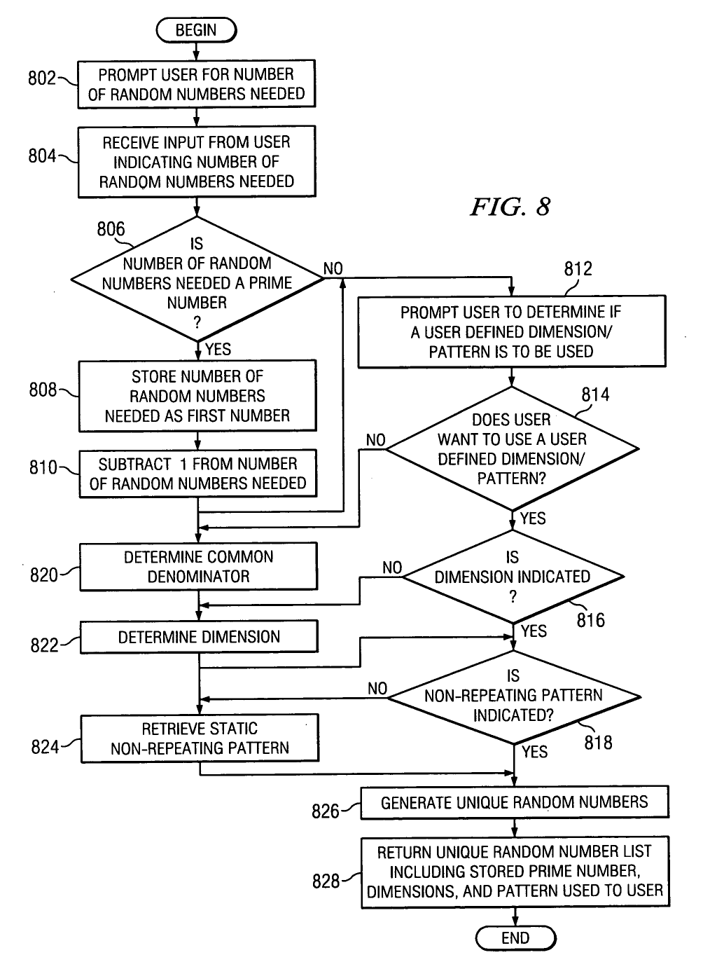

FIG. 8 depicts a flowchart operation for generating pseudo-random numbers using a pseudo-random number generation application in accordance with an illustrative embodiment of the present invention. The pseudo-random number generation application may be an application such as application 304 in FIG. 3.

As the operation begins, the application prompts a requester through a graphical user interface for the number of random numbers needed (step 802). The application then receives the number of pseudo-random numbers as input by the requestor through the graphical user interface (step 804). The application determines if the number of random numbers requested by the requestor is a prime number (step 806). If the number is a prime number, then the number of random number needed is stored as the first number to be returned in the list of random numbers (step 808). For example, if the requestor requests 51 random numbers, 51 would be stored as the first number to be returned in the list of random numbers.

The application then proceeds to subtract 1 from the number of random numbers requested (step 810) with the operation continuing to step 812. Using the example from above, subtracting 1 from 51 would result in the number 50 being used for the remainder of the operation. If at step 806, the number or random numbers requested is not a prime number, the operation continues to step 812. At step 812, the requestor is then prompted for grid dimensions and/or a value set pattern to be used in generating the random numbers. As discussed previously, a requestor may want the same random numbers each time the application is invoked, even across different operating systems. In one inventive aspect of the present invention, reproducible results may be produced, even across different operating systems. In order to provide reproducible results to a requester, the requestor is required to provide the number of random numbers needed, but is also required to provide the dimensions of the grid and the value set pattern that was previously used in generating a list of random numbers.

At step 814, if the requestor indicates that a specific grid dimension and/or value set pattern is to be used, the operation then determines if a grid dimension is indicated by the requester (step 816) and if a specific pattern is indicated by the requester (step 818). If at either of steps 816 or 818, the requestor does not indicate one of the values, the application automatically generates a value for the missing information. The common denominator calculation is not required when a requestor defines at least one of a grid dimension or a static value set pattern, since either the grid dimension or the static value set pattern indicates the common denominators for the requested number of random numbers. The operation then proceeds to step 826, where a set of pseudo-random numbers are generated.

Returning to step 814, if the requester fails to indicate a specific grid dimension and value set pattern to be used, the operation then determines a common denominator for the number of random numbers that are to be generated (step 820). Using the common denominators generated, a grid dimension is generated (step 822) and a static pattern is retrieved based on the grid dimensions (step 824). The operation then proceeds to step 826, where a set of pseudo-random numbers are generated. As should be noted at this point, the operation using the path from 814, 816, 818, to 826 is a pseudo-random number generation path as one or more of the values is defined by a requestor. The operation using the path from 814, 820, 822, 824, to 826 is a random number generation path as none of the values are defined prior to the operation.

After the list of random numbers are generated (step 826), a random number list is returned to the requestor which includes the prime number as the first number if the requested number of random numbers needed was a prime number (step 828). Also returned to the requestor are the dimensions of the grid and the static value set pattern used to generate the list of random numbers.

Thus, the many aspects of the present invention generate an infinite number of random numbers without duplicates based on a much smaller requestor-defined subset. The smaller subset is expanded to fit the target range of random numbers. The described random number generation does not require the requestor to maintain a list of numbers to verify for duplicates. There is a lower overhead in that a unique random number is produced every time the method is invoked, and produces reproducible results, even across different operating systems.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating random numbers, the method comprising:
receiving a request for a number of random numbers;
determining common denominators for the number of random numbers;
determining grid dimensions using the common denominators;
retrieving a static pattern using the grid dimensions;
generating a list of random numbers using the static pattern and the grid dimensions; and
returning the list of random numbers to a requester.

2. The computer implemented method of claim 1, wherein returning the list of numbers to the requestor includes returning the grid dimensions and the static pattern.

3. The computer implemented method of claim 1, wherein determining the common denominators for the number of random numbers further comprises:
determining if the number of random numbers is a prime number;
storing the number of random numbers as a first number in a random number list;
subtracting 1 from the number of random numbers to form a new number of random numbers; and
determining the common denominators for the new number of random numbers.

4. The computer implemented method of claim 1, further comprising:
prompting the requestor for the number of random numbers.

5. The computer implemented method of claim 4, wherein the requestor is prompted in a graphical user interface.

6. The computer implemented method of claim 1, wherein determining the grid dimensions using the common denominators further comprises:
receiving a requestor defined grid dimension; and
using the requestor defined grid dimension as the grid dimensions.

7. The computer implemented method of claim 1, wherein retrieving the static pattern using the grid dimensions further comprises:
receiving a requestor defined static pattern; and
using the requestor defined static pattern as the static pattern.

8. A data processing system comprising:
a bus system;
a communications system connected to the bus system;
a memory connected to the bus system, wherein the memory includes a set of instructions; and
a processing unit connected to the bus system, wherein the processing unit executes the set of instructions to receive a request for a number of random numbers; determine common denominators for the number of random numbers; determine grid dimensions using the common denominators; retrieve a static pattern using the grid dimensions; generate a list of random numbers using the static pattern and the grid dimensions; and return the list of random numbers to a requestor.

9. The data processing system of claim 8, wherein executing the set of instructions to return the list of numbers to the requestor includes executing a set of instructions to return the grid dimensions and the static pattern.

10. The data processing system of claim 8, wherein executing the set of instructions to determining the common denominators for the number of random numbers includes executing a set of instructions to determine if the number of random numbers is a prime number; store the number of random numbers as a first number in a random number list; subtract 1 from the number of random numbers to form a new number of random numbers; and determine the common denominators for the new number of random numbers.

11. The data processing system of claim 8, executing a set of instructions to prompt the requestor for the number of random numbers.

12. The data processing system of claim 11, wherein the requestor is prompted in a graphical user interface.

13. The data processing system of claim 8, wherein executing the set of instructions to determine the grid dimensions using the common denominators includes executing a set of instructions to receive a requestor defined grid dimension; and use the requestor defined grid dimension as the grid dimensions.

14. The data processing system of claim 8, wherein executing the set of instructions to retrieve the static pattern using the grid dimensions includes executing a set of instructions to receive a requestor defined static pattern; and use the requestor defined static pattern as the static pattern.

15. A computer program product comprising:
a computer usable medium including computer usable program code for generating random numbers, the computer program product including:
computer usable program code for receiving a request for a number of random numbers;
computer usable program code for determining common denominators for the number of random numbers;
computer usable program code for determining grid dimensions using the common denominators;
computer usable program code for retrieving a static pattern using the grid dimensions;
computer usable program code for generating a list of random numbers using the static pattern and the grid dimensions; and
computer usable program code for returning the list of random numbers to a requester.

16. The computer program product of claim 15, wherein the computer usable program code for returning the list of numbers to the requestor includes computer usable program code for returning the grid dimensions and the static pattern.

17. The computer program product of claim 15, wherein the computer usable program code for determining the common denominators for the number of random numbers further comprises:
computer usable program code for determining if the number of random numbers is a prime number;
computer usable program code for storing the number of random numbers as a first number in a random number list;
computer usable program code for subtracting 1 from the number of random numbers to form a new number of random numbers; and
computer usable program code for determining the common denominators for the new number of random numbers.

18. The computer program product of claim 15, further comprising:
computer usable program code for prompting the requestor for the number of random numbers.

19. The computer program product of claim 15, wherein the computer usable program code for determining the grid dimensions using the common denominators further comprises:
computer usable program code for receiving a requestor defined grid dimension; and
computer usable program code for using the requestor defined grid dimension as the grid dimensions.

20. The computer program product of claim 15, wherein the computer usable program code for retrieving the static pattern using the grid dimensions further comprises:
computer usable program code for receiving a requestor defined static pattern; and
computer usable program code for using the requestor defined static pattern as the static pattern.
